(19) United States
(12) Patent Application Publication
(10) Pub. No.: US 2026/0243339 A1
(43) Pub. Date: Aug. 20, 2026

(54) Helical Pinion and Helical Gear Transmission

(71) Applicant: Robert Bosch GmbH, Stuttgart (DE)

(72) Inventors: Arian Wolfien, Abtsgmuend (DE); Florian Blumenstock, Waldstetten (DE); Matthias Mueck, Schwaebisch Gmuend (DE); Dennis Fuechsel, Schwaebisch Gmuend (DE); Andreas Eisenhuth, Schwaebisch Gmuend (DE); Roland Baur, Durlangen (DE); Ekkehard Kneer, Wendlingen (DE); Alexander Wertz, Aalen (DE)

(21) Appl. No.: 19/160,569

(22) PCT Filed: Feb. 13, 2024
(86) PCT No.: PCT/EP2024/053595

§ 371 Date: Aug. 28, 2025

(30) Foreign Application Priority Data
Feb. 28, 2023 (DE) 10 2023 201 805.5

(51) Int. Cl. F16H 55/08; B62D 3/04; F16H 1/16; F16H 55/22

(52) U.S. Cl. CPC F16H 55/0846; B62D 3/04; F16H 1/16; F16H 55/22; F16H 55/0806

(57) ABSTRACT

A helical pinion for a helical gear transmission includes at least one tooth gear-that has a globoidal design. The tooth gear has tooth profile contours which constantly change over the course of the tooth gear. The helical pinion may be included in a helical gear transmission that includes the helical pinion and a helical gear.

The invention relates to a helical pinion for a helical gear transmission and a helical gear transmission having such a helical pinion. The helical gear transmission may in particular be provided as a steering gear of a steering system for a motor vehicle.

In most motor vehicles, assistive steering systems are installed that generate assistive torque during steering, thereby reducing the steering torque to be applied by the driver to the steering column.

The known assistive steering systems are based on a steering gear that translates the drive power of a hydraulic or electric steering motor and transmits it to, for example, the steering column. Such steering gears may be configured in the form of a helical gear transmission or a worm gear. These then comprise a tooth gear that may be directly or indirectly connected to the steering column, and a pinion in the form of a helical pinion or worm gear that meshes with it and is driven by the steering motor via a shaft.

The worm gears and helical gear transmissions are tooth gear transmissions in which the rotation axes of the tooth gear and the pinion are each arranged skew to one another and thus neither run parallel (as with a spur gear) nor intersect (as with a bevel gear).

According to the invention, a distinction is made between a worm gear on the one hand and helical gear transmissions on the other hand, in that worm gears have an axis intersection angle of 90° and helical gear transmissions have an axis intersection angle that is not 90°. The “axis crossing angle” is understood to be the angle between 0° and 90° that is formed between the two shaft axes when projected into a plane that runs parallel to both of the shaft axes.

Worm gears and helical gear transmission are generally characterized by relatively quiet performance compared to tooth gear transmissions, which are characterized by an substantially rolling contact due to a permanently sliding relative movement between the tooth flanks of their gear elements. In addition, a worm gear or helical gear transmission may have a relatively high load capacity compared to a tooth gear transmission, which is due to a relatively large overlap of the meshing teeth of the gear components. This relatively large tooth overlap results from the fact that more teeth are typically in mesh simultaneously in a helical gear or worm gear transmission than is the case with a comparatively dimensioned tooth gear transmission.

A relatively large tooth overlap of a gear leads to relatively low Hertzian pressures in the contact areas and thus to relatively low wear and relatively low plastic deformation. The negative impact of wear and deformation on the service life of the transmission can thereby be kept correspondingly low. This also applies to the formation of gear backlash. In the case of steering systems of motor vehicles, gear backlash should be avoided, as this can otherwise lead to acoustic abnormalities. If such backlash cannot be avoided, it can be compensated for by integrating backlash compensation elements. However, this is associated with a significant constructive effort as well as functional disadvantages.

In order to avoid the integration of backlash compensation elements or at least to be able to design them simply, the aim can therefore be to maximize the tooth overlap of the transmission.

Worm gears are typically configured with either cylindrical worms and globoidal worm gears, or with globoidal worms and cylindrical worm gears. With a globoidal worm gear, its teeth are each formed in the direction of their respective longitudinal path with a concave path adapted to the diameter of the associated cylindrical worm. Similarly, in a globoidal worm, the head circles and the base circles each describe a circular section in each axial section (along the rotation axis of the worm). Worm gears with a globoidal worm can be characterized by a greater tooth overlap and thus also a greater load capacity compared to those with a cylindrical worm.

The axle crossing angle of 90° in a worm gear is often disadvantageous when used in a steering system of a motor vehicle, because it provides insufficient flexibility with regard to the use of the available installation space. This limitation is not present in helical gear transmissions with their axis crossing angle not equal to 90°. In addition, the axis crossing angle of 90° in a worm gear requires a helical toothed design configuration of the worm gear, which requires more manufacturing effort compared to a straight-toothed gear, which can be used as a helical gear in a worm gear. However, the known helical gearbox transmissions have the disadvantage that, for geometric reasons, only cylindrical helical pinions can be used, which only have a relatively small tooth overlap with the corresponding helical gear.

The invention is based on the object of specifying a helical gear transmission that has the largest possible tooth overlap.

This problem is achieved in a helical gear transmission according to claim 10, which comprises a helical pinion according to claim 1. A steering system for a motor vehicle with a steering gear in the form of a helical gear transmission according to the invention is the subject matter of claim 14. Advantageous embodiments of the helical pinion according to the invention, the helical gear transmission according to the invention and the steering system according to the invention are the subject matter of the further claims and/or result from the following description of the invention.

A helical pinion according to the invention for a helical gear transmission has at least one tooth gear, possibly multiple, preferably two teeth gears, wherein the pinion is characterized by a globoidal design, such that in each axial section (sectional plane along the longitudinal axis or the axis of rotation) of the helical pinion at least the heads and preferably also the feet of the tooth profile contours describe an arc (i.e. concave) pointing towards the rotation axis of the helical pinion, which in particular can be (in each case) a portion of an ellipse. According to the present invention, this is also referred to as an (elliptical) head curve or as an (elliptical) foot curve. On the (elliptical) head curve, at least that point of the tooth head is located which, in relation to the respective tooth profile contour, has the greatest distance from the axis of rotation of the screw pinion. On the (elliptical) foot curve, on the other hand, there is at least that point of each of the contours of the base of the toothing space (formed between two adjacent sections of the at least one tooth gear) visible in the respective axial section which has the smallest distance from the rotation axis of the screw pinion. Preferably, the entire base of the contours of the toothing space visible in the respective axial section lies on the (elliptical) foot curve.

In addition to a helical pinion according to the invention, a helical gear transmission according to the invention also comprises a helical gear in meshing engagement therewith, which may preferably be cylindrical. As a helical gear transmission, the rotation axes of the helical pinion and the helical gear have an axis crossing angle that is not equal to 90°.

Accordingly, the invention provides for a globoidal design of a helical pinion in a helical gear transmission, which is made possible by the fact that the at least one tooth gear, or all of these tooth gears in the case of several tooth gears, of the helical pinion has constantly changing tooth profile contours over its (respective) entire travel. In each axial section (i.e. in each cutting plane along the rotation axis of the helical pinion), there are therefore only different tooth profile contours (i.e. outer contours of the cutting surfaces of the at least one tooth gear in the respective axial section).

A helical gear transmission according to the invention combines the flexibility with regard to the utilization of installation space, which can result from an axis crossing angle not equal to 90°, with the advantage of a relatively large tooth overlap, which was previously only achievable with a worm gear with a globoidal worm, but then with a shaft crossing angle of 90°.

According to a preferred embodiment of a helical gear transmission according to the invention, it can be provided that the helical gear is straight-toothed so that all of the teeth of the helical gear run parallel to the rotation axis of the helical gear. This may have an advantageous effect in terms of the manufacturability of the helical gear and thus the manufacturing costs for it and consequently for the entire helical gear transmission.

The axle crossing angle in a helical gear transmission according to the invention may preferably be between 60° and <90°, for example 75°, which may be advantageous with regard to the performance characteristics of the helical gear transmission and/or with regard to the most compact possible design of the helical gear transmission. Particularly with such an axle crossing angle, a combination with a straight-toothed helical gear can also be realized in an advantageous manner.

An advantageous meshing engagement in a helical gear transmission according to the invention can be realized by the fact that all tooth profile contours of the helical pinion, possibly with the exception of one tooth profile contour, are asymmetrical and thus each have two unequal tooth flank shapes. The one symmetrical tooth profile contour, which can be of an involute design, can in particular be located in a (nominal) tooth profile course center (i.e., the center of the entire course of the at least one tooth profile) and/or represent a transition between different, in particular opposing asymmetries, which the tooth profile contours can exhibit starting from the tooth profile course center in the two course directions. The symmetrical tooth profile contour can advantageously be the starting point for production of the helical pinion and, in particular, the at least one tooth gear by milling, for example.

An advantageous meshing engagement in a helical gear transmission according to the invention can further be realized by the fact that in the helical pinion, starting from the tooth gear course center (in the two course directions), the tooth flanks lying on the outside (or more distant from the center of the tooth path) have an increasing concavity over the respective partial course of the tooth course and/or the tooth flanks of the individual tooth profile contours lying on the inside (or closer to the center of the tooth course) have an increasing convexity over the respective partial course of the tooth course. It can be particularly preferably provided that the increase of the concavity of the outer tooth flanks is greater than the increase of the convexity of the inner tooth flanks.

A corresponding asymmetry of the tooth profile contours can advantageously be designed and/or made recognizable by placing measuring balls of different diameters in the tooth profile and connecting the centers of the measuring balls with a straight line. The diameters of the measuring balls can in principle be chosen as desired, wherein they should be large enough to avoid contact with the base of the tooth gear. The asymmetry of the tooth profile contours then results in the straight having an increasing inclination to the respective normal of the foot curve over the respective partial curve of the tooth gear.

The tooth gear course center of the at least one tooth gear may preferably be in overlap with the rotation axis of the helical pinion with the axis crossing point of the helical pinion. The axis crossing point is respectively the point on the rotation axis of the helical pinion and on the rotation axis of the helical gear, which is determined by the shortest distance between these rotation axes.

It can preferably be provided that the at least one tooth gear of the helical pinion over its entire course has a constantly changing distance of a measuring ball center point to the associated foot curve. A “measuring ball center” is understood to mean the center of a (measuring) ball that is dimensioned to only contact the tooth flanks (and not also the base of toothing space) when rolling in the toothing space formed between adjacent portions of the at least one tooth gear.

An advantageous meshing engagement in a helical gear transmission according to the invention can further be realized by the fact that the at least one tooth gear of the helical pinion has constantly changing tooth heights over its entire course. The tooth height is determined by the shortest distance between the head curve and the foot curve within the individual tooth profile contours.

Furthermore, in a helical gear transmission according to the invention, an advantageous meshing engagement can be realized by the fact that the tooth gear has constantly changing tooth head shapes over its entire course. The variability of the tooth head shapes can result in particular from changes in the tooth head thickness and/or the tooth head rounding. The tooth tip is the part of the tooth profile contour that is located in the area of the head curve. Markings for dimensioning of the tooth head thickness, tooth head rounding and tooth curve radius (distance between the rotation axis and the tooth head curve) are shown in FIG. 16.

The invention also relates to a steering system comprising a steering gear, wherein the steering gear is or comprises a helical gear transmission according to the invention. Further, the steering system may comprise a steering motor rotationally connected to the helical pinion, which may in particular be hydraulic or electrical. The helical gear of the helical gear transmission may further be connected to a steering shaft, in particular a steering column, of the steering system in a rotationally fixed or rotationally driving manner. The steering system according to the invention can in particular be designed as an assistive steering system, in which an assistive torque can be generated by means of the steering motor, such that a steering torque to be applied to a steering column by a driver of a motor vehicle comprising the assistive power steering system for steering of the motor vehicle is reduced (possibly even temporarily to zero). Alternatively, it is also possible to design the steering system in such a way that the steering motor always generates the entire steering torque required for steering, in particular to realize a so-called steer-by-wire functionality of the steering system or the motor vehicle, in which there is no mechanical connection between a steering handle (if provided) and the steerable wheels.

The invention also relates to a motor vehicle with a steering system according to the invention.

The invention is explained in more detail in the following with reference to the exemplary embodiment shown in the drawings. The drawings show:

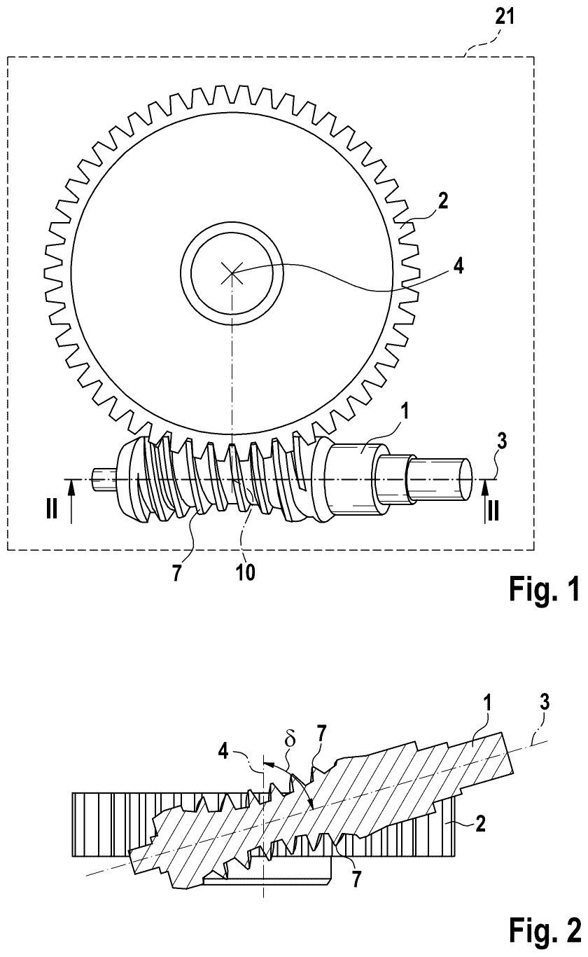

FIG. 1 a side view of a helical gear transmission according to the invention;

FIG. 2: the helical gear transmission in a sectional view according to the section plane II-II in FIG. 1;

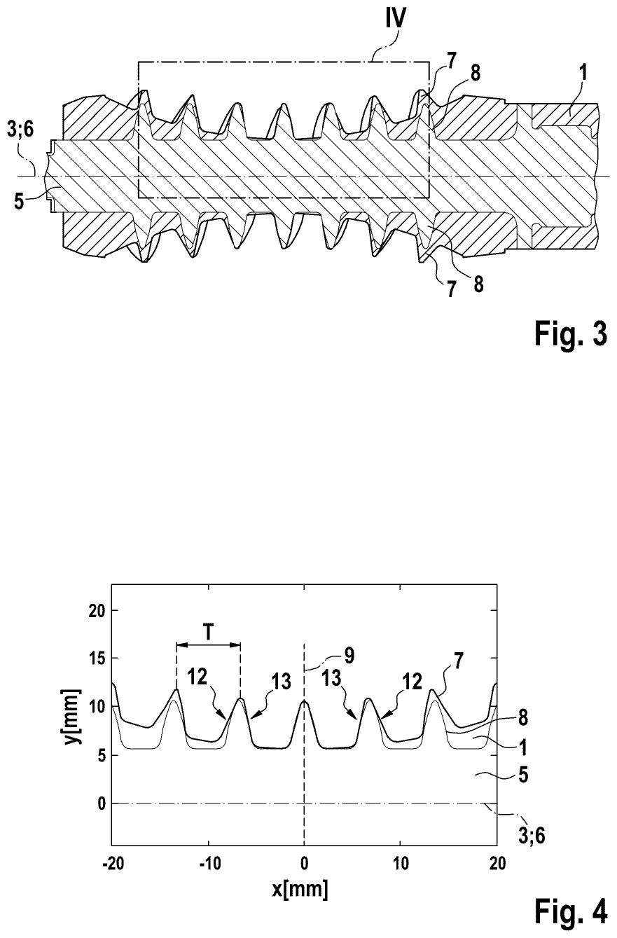

FIG. 3: in a superimposed illustration, axial sections of the helical pinion of the helical gear transmission and a similarly dimensioned cylindrical worm (with thinner lines), each at a rotation angle defined as 0°;

FIG. 4: the section labeled IV in FIG. 3 in enlarged representation in conjunction with a reference coordinate system, wherein the axial zero value (on the x-axis) in this axial section corresponds to a tooth gear course center;

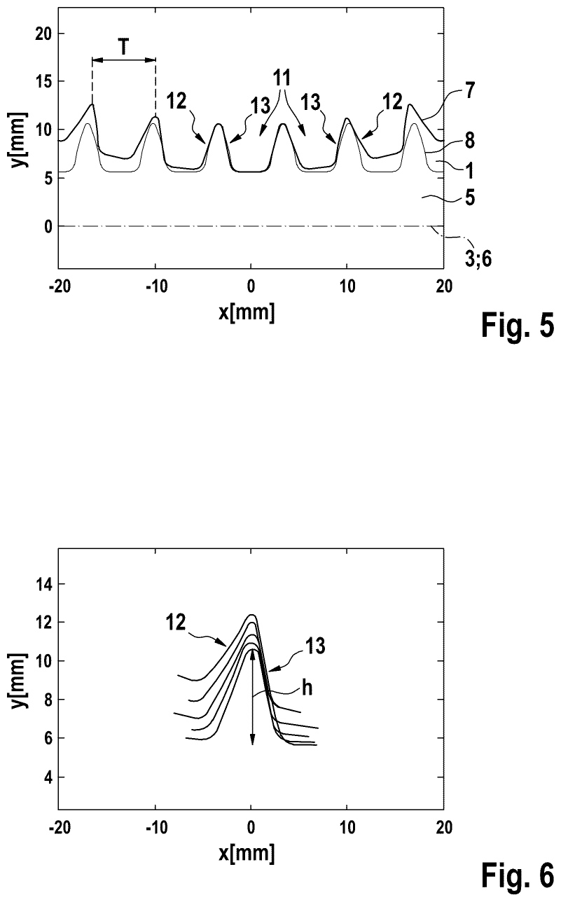

FIG. 5: an axial cut of the helical pinion and the cylindrical worm according to FIG. 4, but at a rotation angle of 90°;

FIG. 6: a translational displacement of all tooth profile contours of the helical pinion according to the invention, which are located on the left of the axial zero value in FIGS. 4 and 5 and are completely detectable, into the tooth gear course center (the tooth profile contour located in the tooth gear course center in FIG. 4 is excluded);

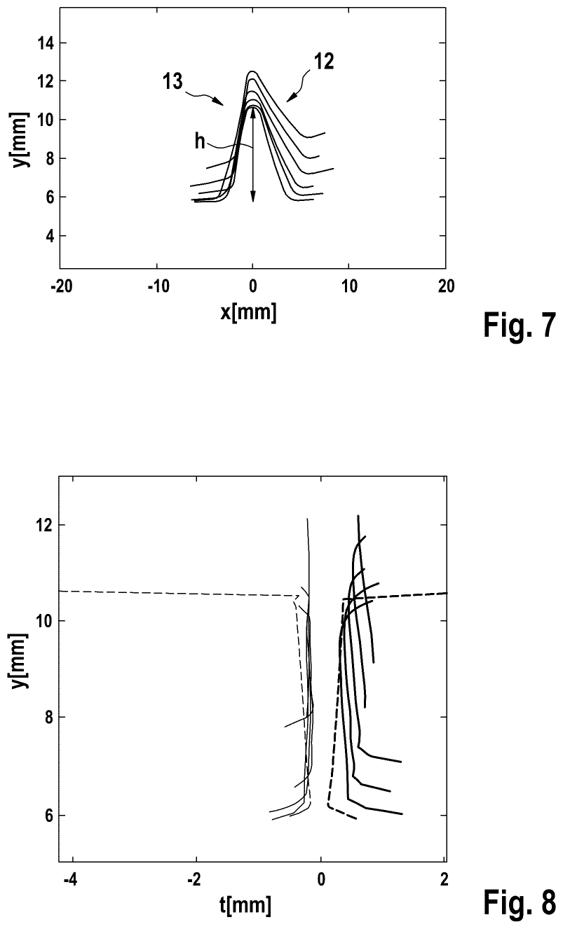

FIG. 7: a translational displacement of all tooth profile contours of the screw pinion according to the invention, which are located to the right of the axial zero value in FIGS. 4 and 5 and are completely detectable, into the tooth gear course profile (the tooth profile contour located in the tooth gear course center in FIG. 4 is taken into account);

FIG. 8: the courses of the curvature radii of the tooth flanks above the respective associated tooth height of all of the tooth profile contours of the helical pinion according to the invention, which are located on the left of the axial zero value in FIGS. 4 and 5 and are completely detectable;

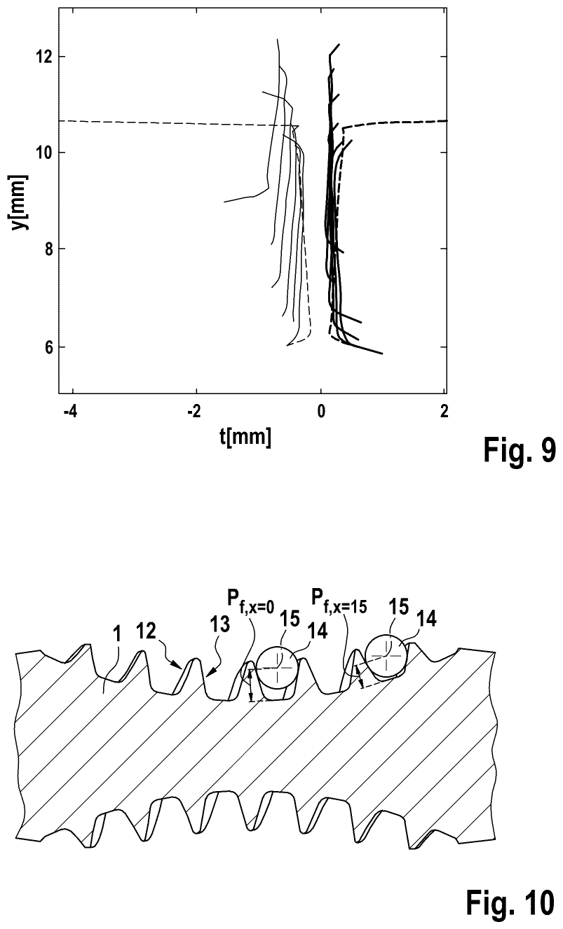

FIG. 9: the changes of the curvature radii of the tooth flanks above the respective associated tooth height of all of the tooth profile contours of the helical pinion according to the invention, which are located on the right of the axial zero value in FIGS. 4 and 5 and are completely detectable;

FIG. 10: the helical pinion in an axial cut in combination with a measuring ball, with two positions of this measuring ball shown.

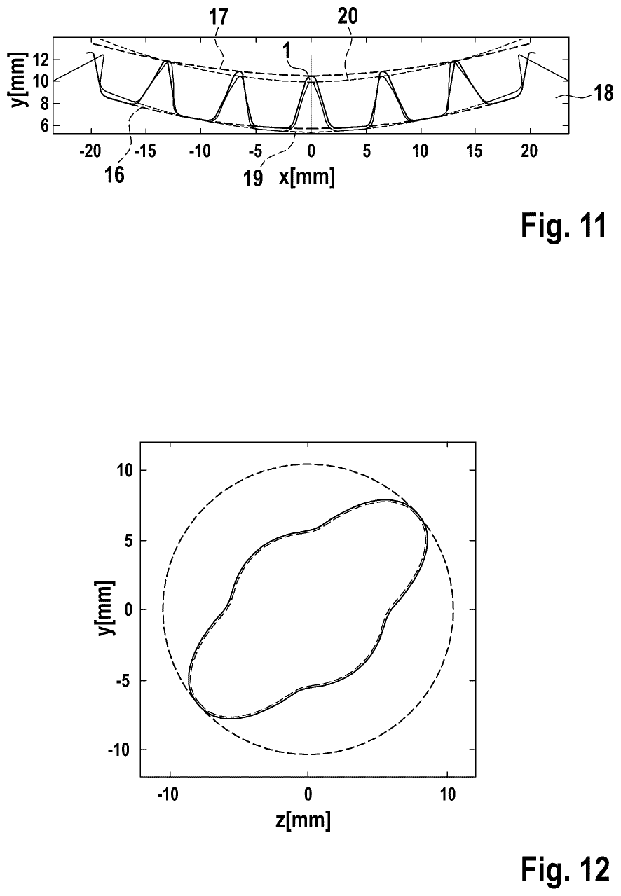

FIG. 11: an illustration comparable to FIG. 4, wherein a corresponding section of a globoidal worm (with thinner line guide) is shown instead of the cylindrical worm for comparison with the helical pinion according to the invention;

FIG. 12: a radial cut through the helical pinion and the cylindrical worm (dashed line guide) at the tooth gear course center;

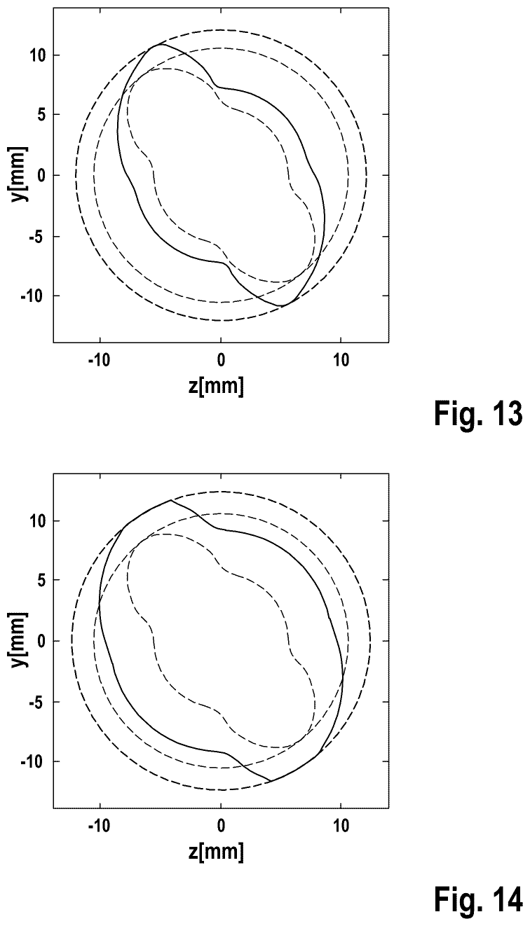

FIG. 13: a radial section through the helical pinion and the cylindrical worm (dashed line guide) at a position displaced by two divisions of the tooth gears compared to the radial section according to FIG. 12;

FIG. 14: a radial section through the helical pinion and the cylindrical worm (dashed line guide) at a position displaced by two divisions of the tooth gears compared to the radial section according to FIG. 12;

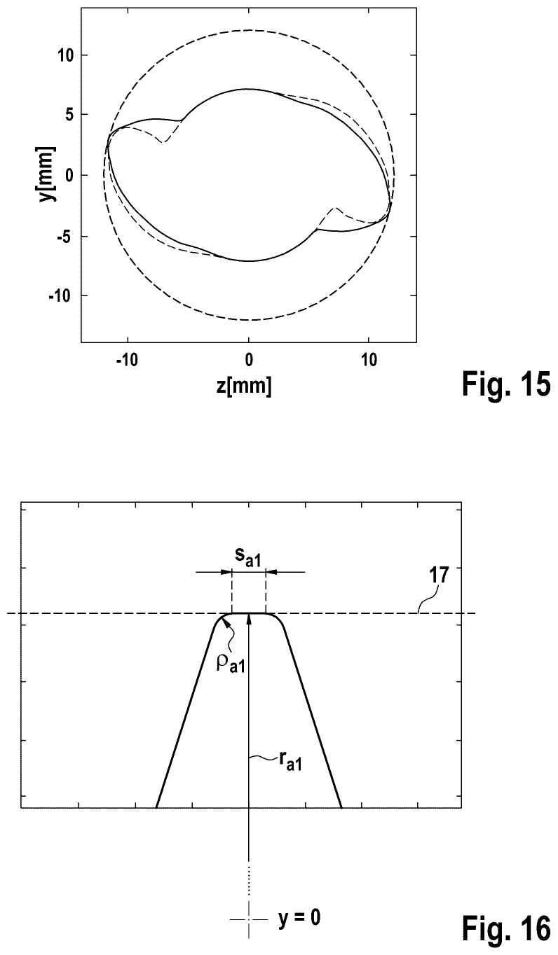

FIG. 15: a radial section according to FIG. 13 through the helical pinion and the globoidal worm (dashed line guide);

FIG. 16: a section with tooth head of a tooth profile contour with dimension marking; and

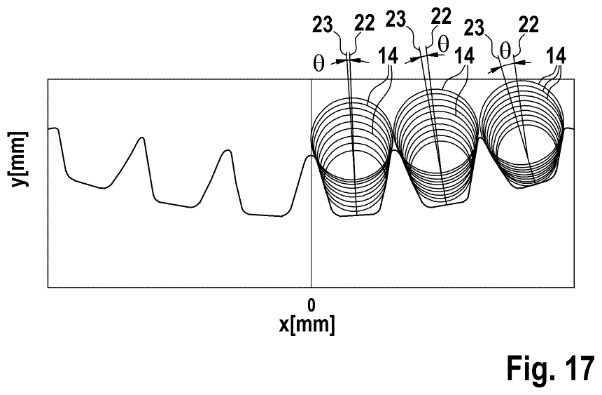

FIG. 17: the helical pinion in an axial section in combination with a plurality of measuring balls having different ball diameters, whereby these measuring balls are each shown in three different x positions within the tooth gear.

FIGS. 1 and 2 show a helical gear transmission according to the invention having a globoidal helical pinion 1 and a helical gear 2, which is cylindrical and straight-toothed. Due to the design as a helical gear, the rotation axes 3, 4 of the helical pinion 1 and the helical gear 2 include an axis crossing angle y not equal to 90°, specifically an axis crossing angle y of 75°. The helical gear transmission is provided as a steering gear of a steering system 21 for a motor vehicle.

FIG. 3, as well as FIG. 2, shows the helical pinion 1 in an axial cut in a rotary orientation (about its rotation axis 3), which is defined as 0°. FIG. 3 also shows a similarly dimensioned, conventional cylindrical worm 5 in a superimposed representation and with thinner lines, also in an axial section.

FIG. 4 shows the section marked IV in FIG. 3 in an enlarged representation in conjunction with a reference coordinate system, wherein the horizontal axis (x-axis) of the reference coordinate system extends parallel to the (collinear) rotation axes 3, 6 of the helical pinion 1 and the cylindrical worm 5 and the vertical axis (y-axis) in a direction radial to these rotation axes 3, 6. The zero value of the horizontal axis (x=0) is assigned to the tooth gear course center 9 of the tooth gears 7, 8 of both the helical pinion 1 and the cylindrical worm 5, whereby the tooth gear course center 9 represents the exact center in the threaded or helical entire path of the individual tooth gears 7, 8 of the helical pinion 1 and the cylindrical worm 5 and is arranged in the axis crossing point 10 of the helical pinion 1 in the helical gear transmission according to the invention (see FIG. 1). In the illustrated design example, both the helical pinion 1 and the cylindrical worm 5 each have two tooth gear 7, 8 arranged offset by 180° with respect to the respective associated axis of rotation 3, 6, but which are otherwise identical.

FIG. 5 shows an axial cut of the helical pinion 1 and the cylindrical worm 5 with a rotation angle of 90° in each case, which results in the zero value of the horizontal axis of the reference coordinate system being located in the meshing space 11 of each of the tooth gears 7, 8.

As already shown in FIGS. 3 to 5, the features described below are characteristic of the helical pinion 1 according to the invention.

Each of the tooth gears 7 of the helical pinion 1 has constantly changing tooth profile contours over its entire course. This can result in an involute tooth profile contour for the (nominal) tooth gear course center 9 of the tooth gears 7, which is essentially identical to the tooth profile contour of the tooth gears 8 of the cylindrical worm 5 (which remains constant over the entire course). This can be seen in FIG. 4 due to the substantially exact overlap of the tooth profile contours located at the zero value of the horizontal axis.

Starting from the tooth gear course center 9, the tooth flanks 12 lying on the outside in each of the two directions have an increasing concavity over the respective partial course of the individual tooth gears 7. In contrast, for the respective internal tooth flanks 13, there is an increasing convexity over the respective partial curve of the individual tooth ducts 7, wherein the respective increase in the concavity of the external tooth flanks 12 is greater than the increase in the convexity of the inner tooth flanks 13.

Due to the constant and different changes in the shapes of the different tooth flanks 12, 13, it results that all tooth profile contours are designed asymmetrically except for the tooth profile contour of the individual tooth gears 7 located in the respective teeth course center 9. These asymmetries can be seen even more clearly in FIGS. 6 to 9 and 17. In FIG. 6, all of the tooth profile contours that are shown in FIGS. 4 and 5 to the left of the zero value and thus in the negative value range of the horizontal axis (complete) are shown superimposed by a translational displacement in the tooth gear course center 9. The tooth profile contour lying in the tooth gear course center 9 in FIG. 4 is not taken into account. In FIG. 7, all of the tooth profile contours that are located to the right of the zero value in FIGS. 4 and 5, and thus in the positive value range of the horizontal axis (shown in full), are shown superimposed by a translational displacement into the tooth gear course center, whereby in this case the tooth profile contour located in the tooth gear course center 9 in FIG. 4 is taken into account.

FIG. 17 shows that the opposing asymmetries of the tooth profile contours (left to right flank) in the two directions (1. x=0→x>0 2. x=0→x<0) results in a straight line 22 that is defined by the ball centers of several measuring balls 14 of different ball diameters. The straight line 22 is increasingly inclined from the tooth gear course center 9 (x=0) to the normal (or orthogonal) 23 of the foot curve 16 over the individual partial profiles of the tooth profile 7. The change in inclination is opposite in the two directions of travel. In FIG. 17, the change in inclination is illustrated only for one direction of travel (1st x=0→x>0). In the other direction of travel, there is a mirror-image change in the inclination of such a straight line. Such an angle of inclination θ between the straight lines 22 and 23 only occurs with a screw pinion according to the invention. In the case of a globoidal worm with axis crossing angle s=90°” and a cylindrical worm with an axis crossing angle <=90°, the straight lines 22 and 23 always coincide.

It can also be seen in FIGS. 6 and 7 that the teeth gears 7 of the helical pinion 1 according to the invention each have a constantly changing tooth height h over their entire courses. Even constantly changing tooth head shapes, in particular with regard to the respective tooth head thickness sa1 and the rounding of the tooth head Δa1, are also detectable (cf. also FIG. 16).

FIGS. 8 and 9 show the respective profiles and thus the changes of the radii of curvature t (on the horizontal axis) of the tooth flanks 12, 13 above the tooth height h (vertical axis). The courses of the left tooth flanks, grouped to the right in the respective diagram, are drawn with thicker lines and the courses of the right tooth flanks, grouped to the left in the respective diagram, are drawn with thinner lines. FIG. 8 again shows the tooth profile contours to the left of the zero value (x=0) in FIGS. 4 and 5, while FIG. 9 shows the tooth profile contours to the right of the zero value and those in the zero value. The increase in the concavity of the outer tooth flanks 12 in the respective course is clearly shown. The increase of the convexity of the inner tooth flanks 13 in the respective course directions is indeed present, but relatively low. For comparison, the curves of the curvature radii of the cylindrical worm are additionally shown with dashed line in FIGS. 8 and 9.

The tooth gears 7 of the helical pinion according to the invention are configured such that they each have a constantly changing distance Pf of a measuring ball center point 15 to the associated foot curve 16 as a function of the coordinate x over their overall courses. This is shown in FIG. 10 for two example positions of a corresponding measuring bead 14 at x=0 (P_{f,x=0}) and x=15 mm (Pf_{,x=15}).

The helical pinion 1 according to the invention is further characterized in that the tooth profile contours describe elliptical head curves 17 and foot curves 16. This can be seen in particular from FIG. 11, in which one of these head curves and foot curves 16, 17 are respectively drawn. In addition to or instead of the cylindrical worm 5, a comparably dimensioned globoidal worm 18 is shown with thinner lines, whose tooth profile contours, which, as with the cylindrical worm 5, are constant or unchanged over the entire course, describe circular foot curves 19 and head curves 20.

The constantly changing tooth profile contours of the tooth gears 7 of the helical pinion 1 according to the invention are also clearly discernible in FIGS. 12 to 15, which show the helical pinion 1 in a radial section (i.e., a section plane lying perpendicular to the rotation axis 3). FIG. 12 shows a radial section in the (identically located) tooth gear course center 9 of the tooth gears 7 (axial zero point in FIGS. 4 and 5), FIG. 13 shows a radial section at a position which, starting from the tooth gear course center 9 is shifted by two divisions T of the tooth gears 7 in the positive direction along the horizontal axis, and FIG. 14 shows a radial section at a position that is shifted by two divisions T of the tooth gears 7 in the positive direction of the horizontal axis starting from the tooth gear course center 9. In FIGS. 12 to 14, corresponding radial sections of the cylindrical worm 5, also shown as a comparison in FIGS. 3 to 5, are also shown.

FIGS. 12 to 14 show the constantly changing tooth profile contours of the tooth gears (at three exemplary positions) and thereby particularly clearly their asymmetries-with the exception of the tooth profile contours in the tooth gear course center 9 (cf. FIG. 12), as well as the constantly changing tooth heights h of the tooth gears 7.

FIG. 15 shows the radial section of the helical pinion 1 according to the invention as shown in FIG. 13 in comparison with a corresponding radial section through the globoidal worm 18, which is also shown comparatively in FIG. 11.

1. A helical pinion for a helical gear transmission, comprising:
at least one tooth gear having a globoidal design, the at least one tooth gear having tooth profile contours which constantly change over the entire course of the tooth gear.

2. The helical pinion according to claim 1, wherein all of the tooth profile contours are asymmetrical.

3. The helical pinion according to claim 1, wherein, starting from a tooth gear course center, respective outer tooth flanks have an increasing concavity over the a respective partial course of the tooth gear.

4. The helical pinion according to claim 1, wherein, starting from a longitudinal axial tooth gear course center, respective inner tooth flanks have an increasing convexity over a respective partial course of the tooth gear.

5. The helical pinion according to claim 3, wherein:
starting from the tooth gear course center, respective inner tooth flanks have an increasing convexity over a respective partial course of the tooth gear, and the increase of the concavity of the outer tooth flanks is greater than the increase of the convexity of the inner tooth flanks.

6. The helical pinion according to claim 1, wherein, in each axial cut, heads and/or feet of the tooth profile contours describe a section of an ellipse.

7. The helical pinion according to claim 1, wherein the at least one tooth gear has a constantly changing distance of a measuring ball center point from a foot curve over the entire course.

8. The helical pinion according to claim 1, wherein the at least one tooth gear has constantly changing tooth heights over the entire course.

9. The helical pinion according to claim 1, wherein the tooth gear has constantly changing tooth head shapes over the entire course.

10. The helical gear transmission comprising:
the helical pinion according to claim 1;
and a helical gear.

11. The helical gear transmission according to claim 10, wherein the helical gear is straight-toothed.

12. The helical gear transmission according to claim 10, wherein a tooth gear course center of the helical pinion lies in overlap with an axis crossing point of the helical pinion.

13. The helical gear transmission according to claim 10, wherein the helical gear is cylindrical.

14. A steering system for a motor vehicle comprising:
a steering gear that is or comprises the helical gear transmission according to claim 10.

15. The helical pinion according to claim 2, wherein all of the tooth profile contours with the exception of one tooth profile contour are asymmetrical.
